(19) United States
(12) Patent Application Publication
(10) Pub. No.: US 2011/0220798 A1
(43) Pub. Date: Sep. 15, 2011

(54) RADIATION DETECTOR WITH DOPED OPTICAL GUIDES

(75) Inventors: Arnd Friedrich Baurichter, Erlangen (DE); Christian Skou Søndergaard, Arhus c (DK); Martin Kristensen, Arhus V (DK); Bjarne Funch Skipper, Odder (DK); Kenneth Hansen, Hinnerup (DK)

(73) Assignee: Siemens A/S, Jyllinge (DK)

(21) Appl. No.: 13/130,265

(22) PCT Filed: Nov. 19, 2009
(86) PCT No.: PCT/DK2009/050307

§ 371 Date: May 19, 2011

(30) Foreign Application Priority Data
Nov. 21, 2008 (DK) PA200801642

(51) Int. Cl. G01T 1/20; G01J 5/10; B23P 11/00

(52) U.S. Cl. 250/337; 250/362; 250/361 R; 250/338.1; 29/428

(57) ABSTRACT

The invention relates to a radiation detector suitable for use in connection with particle therapy applications. The detector comprises at least one set of scintillating optical guides which upon exposure to incident radiation generate scintillating light. The optical guides are arranged in an array, such as in a so-called harp configuration, for detecting a transversal radiation beam profile. The scintillating optical guides are provided in a glass-based material doped with a rare earth dopant. Of particular interest are the rare earth materials: Ytterbium, Holmium, Thulium and Erbium.

### FIELD OF THE INVENTION

The invention relates to a radiation detector and in particular to a radiation detector comprising optical guides which upon exposure to incident radiation generate scintillating light.

### BACKGROUND OF THE INVENTION

Particle radiation from an accelerator facility can be used for a number of purposes, such as within various domains of fundamental research as well as for the application of particle therapy. In particle therapy localized cancer tumours are treated by exposure to particles such as protons and heavy ions as for example Carbon ions. Treatment with particles has the advantage, that the deposited energy can be localized to a higher extent in the cancer tissue than is possible with x-ray treatment.

In a particle treatment facility, particles are produced in an accelerator complex, such as a synchrotron or cyclotron, and extracted via an extraction line to a treatment chamber for irradiation of the patient. In connection with extraction of the particle beam the transversal beam profile is monitored. Traditionally a so-called multi-wire proportional chamber (MWPC) is used for this purpose. However, the MWPC is an expensive and complex device.

Alternatives for the MWPC detectors for monitoring the transversal beam profile have been proposed. In the published International patent application WO 2007/093735 A2 a detector which is based on an array of parallel optical fibres that produce light signals when the particle beam passes through the fibre array is disclosed. The scintillating optical fibres of this disclosure are based on the plastic material polystyrene. It is, however, a disadvantage to use plastic materials, since such materials degenerate upon prolonged exposure and frequent change of the detecting element is therefore necessary.

The inventors of the present invention have appreciated that an improved detector for detecting incident radiation would be of benefit, and have in consequence devised the present invention.

### SUMMARY OF THE INVENTION

The present invention seeks to provide an improved radiation detector for detecting incident radiation based on detecting scintillating light generated by radiation penetrating optical guides. Preferably, the invention alleviates, mitigates or eliminates one or more disadvantages of the prior art, singly or in any combination.

It may be seen as an object of the present invention to provide a detector which is resistant to extensive radiation. A further object may be to provide a detector which is capable of detecting a large range of radiation intensities and energies with a high sensitivity to the incident radiation. A yet further object may be to provide a detector, which is relatively simple to produce and maintain, thereby rendering it attractive from a commercial point of view. A yet further object may be to provide a detector suitable for use in connection with particle therapy applications.

To this end, in a first aspect, the invention relates to a radiation detector for detecting incident radiation, the detector comprising:

at least a first detector element, the detector element comprising a set of scintillating optical guides arranged in an array for detecting a transversal radiation beam profile; where radiation incident on an optical guide generates scintillating light signals within the optical guide; and
wherein the scintillating optical guides are provided in a glass-based material doped with a rare earth dopant.

By providing glass-based rare earth doped scintillating optical guides in an array, a sensitive radiation-resistant detector is provided, which is capable of detecting a transversal radiation beam profile. The beam profile is detected from the arrangement of the optical guides, whereas the radiation resistance and the sensitivity are provided from the combination of glass material and the rare earth doping.

The arrangement of the optical guides may be an arrangement of the guides in a common plane in a linear array. This would directly provide the transversal beam profile in a direction perpendicular to the linear arrangement. By use of two detector elements with orthogonal linear arrangements, the transversal beam profile can be provided in orthogonal directions of the transversal plane to the beam. Other arrangements of the guides can also be envisioned.

The detector is suitable for detecting any kind of radiation capable of generating scintillation light in the optical guides. However, the detector is especially suitable for detecting ionizing radiation beams with sufficiently large energy for penetrating the optical guides. A general example of suitable ionizing beams include, but are not limited to, ion beams of any mass and of any charge. Examples of specific ionizing beams include, but are not limited to, proton beams and heavy ion beams, as for example, but not exclusively Carbon ion beams. Further examples, includes also such radiation beams as beam of antiparticles, such as anti-protons. More specifically, the detector is sensitive and radiation resistive in the intensity and energy range used by particle therapy. A detector is thereby provided which is capable of detecting particle beams suitable for particle therapy. In embodiments, the detector may consequently be referred to as a particle beam detector. In the context of the present disclosure, the term “penetrating” refers both to the situation where the radiation beam is capable of penetrating at least to a part of the optical guide being doped with the rare earth dopant; and also to the situation where the radiation beam is capable of penetrating all the way through the optical guide without being stopped by the optical guide.

In the context of the present disclosure the term “optical guide” may include, but is not limited to, optical fibres (multi-mode and single-mode) and integrated waveguides. An integrated wave guide may trap light in a length of material, the material being surrounded by another material with a different index of refraction. A wave guide may be fabricated by depositing material on top of a substrate and etching unwanted portions away, or etching trenches in the substrate and filling them with light-transmitting materials, or from a combination of the two.

The rare earth material is advantageously selected from the group consisting of Ytterbium, Holmium, Thulium and Erbium. These rare earth elements have especially suitable electronic structures which upon excitation from the interaction with the incident radiation favour radiation at well-defined wavelengths upon de-excitation. Moreover, these rare earth elements possess a high cross-section for scintillation. Especially Ytterbium possesses a number of advantageous properties, which renders it suitable as dopant. Examples of such properties include, but are not limited to, an advantageous electronic structure, low tendency to create non-radiating de-excitation channels upon clustering, low probability of interaction with defect states in the glass-based material, and a high cross-section for scintillation.

The glass-based material of the optical guides is advantageously selected as silicate-glass based, i.e. SiO₂-based glass. Preferably the silicate-glass is of a high-purity so that only few defect states are present. However, small concentrations of dopants other than the rare earth dopants may be present, such as Aluminium, Tantalum, Germanium-oxide, etc. Commercial optical guides in the form of optical fibres are typically only available with small concentrations of dopants, which are provided there for various reasons. The electronic structure of Holmium, Thulium, Erbium and especially Ytterbium match the electronic structure of silicate-based glass very well with respect to the desired properties of the detector of embodiments of the present invention.

It is desirable to provide a detector where the ratio between clustered dopant species and isolated dopant species is as low as possible in order to avoid non-radiating de-excitation channels, which may occur in connection with clustering. However, especially Ytterbium is less sensitive to clustering, and a ratio between clustered dopant species and isolated dopant species as high as 50% may be accepted with Ytterbium.

A large range of dopant concentration may be used in various embodiments. The range may be a range between 0.1 per mil to 10 percent in weight. The specific concentration may be determined based on the desired specifications of the detector and what is available from the provider of the optical guides. The fabrication process of rare earth doped glass-based optical fibres is a complicated process; consequently a continuous range of dopant concentrations may not be available for at least this type of optical guide. However, it is an advantage of embodiments of the present invention that a working detector may not be very sensitive to a specific concentration.

In an advantageous embodiment, the optical guide is in the form of an optical fibre, where the optical fibre does not comprise a polymer coating. Typical commercially available fibres do comprise polymer coatings. However, such coatings are advantageously removed. It is advantageous to remove the polymer coating, since such material may decompose from the radiation exposure which is undesired both inside and outside the beam pipe, and even introduce undesired light from the interaction with the radiation beam.

It is an advantage of embodiments of the present invention that the output of the detector is linear, or at least linear to a large degree, with the intensity of the incoming beam.

In an advantageous embodiment the optical guides have been pre-treated by exposure to penetrating ionizing radiation. It has been observed that optical guides in the form of virgin optical fibres are less sensitive to radiation, i.e. have a smaller radiation yield, than fibres that have been exposed to penetrating ionizing radiation. By pre-treatment it may be ensured that the detector is homogeneous in sensitivity over the entire active detector area already from the onset. Moreover, it may be ensured that detectors, which are used in connection with low intensity applications, do not change in sensitivity during use. For detectors to be used in high intensity applications it may not be necessary to pre-treat the optical guides. In an embodiment, the penetrating radiation is penetrating protons or penetrating heavy ions.

It has been observed that optical guides in the form of virgin Yb-doped optical fibres have a very low concentration of Yb in the second ionization state (Yb²⁺) when embedded in the glass material and that most, if not all, of the Yb is present in the third ionization state (Yb³⁺). Upon exposure to radiation it has been observed that the concentration of Yb²⁺ increases, and since it has also been observed that the sensitivity of Yb-doped optical fibres upon pre-exposure to radiation increases, it may be advantageous to provide a detector where the ratio Yb²⁺/Yb³⁺ is larger than 1%. This introduction of Yb²⁺ may be via exposure to radiation or via any other possible way.

In an advantageous embodiment the detector further comprises a heating element for heating the scintillating optical guides. The effect of heating the scintillating optical guides is a short increase in detected scintillating light, possibly due to a release of stored energy from prior radiation in long-lived electronic states upon a temperature increase. The increase in detected scintillating light from the temperature-rise may only last for a given time period, and the optical guides may be heated in succeeding cycles separated by time periods without heating or with active cooling. The heating cycle may advantageously be correlated with a gating signal to provide a detection cycle enabling a high constant sensitivity, as for example by using lock-in techniques.

In an embodiment each scintillating optical guide is coupled to a photodetector for detecting the generated scintillating light signal. The coupling between the scintillating optical guides and the photodetector may be based on optical guides, such as transport guides enabling a separation of the detector itself and the photodetector. The photodetector should be sensitive in the wavelength range where the scintillating light is generated, for rare earth materials and especially for Yb the photodetector should be capable of detecting electromagnetic radiation in the near-infrared range. For Yb-doped optical guides, the photodetector should be capable of detecting radiation in the range between 900 nanometers (nm) and 1200 nm, such at a range surrounding 1050 nm, which is the dominant wavelength for Yb generated scintillation light.

In embodiments, the detector may be a particle beam detector for use in connection with incident radiation that is suitable for particle therapy. A particle beam detector for particle therapy, which is sensitive and radiation-resistant, may thereby be provided. Examples of radiation that is suitable for particle therapy includes, but are not limited to, proton beams and heavy ion beams accelerated to more than 10 MeV, to more than 50 MeV and even to more than 100 MeV. In an embodiment, the detector may be used for protons with energy in the range 10 to 250 MeV/u, such as 48-220 MeV/u; having an intensity in the range 10⁶ to 10¹¹ particles/sec, such as 4×10⁶ to 4×10¹⁰ particles/sec. In another embodiment, the detector may be used for Carbon ions with energy in the range 50 to 250 MeV/u, such as 88-220 MeV/u; having an intensity in the range 10⁴ to 10¹⁰ particles/sec, such as 10⁵ to 10⁹ particles/sec.

In a second aspect, the invention relates to a method of fabricating a radiation detector for detecting incident radiation, the method comprising:
providing a set of scintillating optical guides, the scintillating optical guides being provided in a glass-based material doped with a rare earth dopant; and
arranging the set of scintillating optical guides in at least a first detector element, by arranging the optical guides in an array for detecting a transversal radiation beam profile.

A radiation detector in accordance with the first aspect may thereby be fabricated.

The optical guides may either prior to or after arranging the guides in the detector element be exposed to penetrating ionizing radiation. In an embodiment, the penetrating radiation is penetrating protons or penetrating heavy ions.

In a third aspect, the invention relates to a method of operating a radiation detector; the radiation detector is provided in accordance with the first aspect and further equipped with a heating element and a photodetector, wherein the method comprises:

a) maintaining the scintillating optical guides at a first temperature level;
b) raising the temperature of the scintillating optical guides to a second temperature level;
c) while the temperature of the scintillating optical guides is at the second temperature level; detect the scintillating light generated by the incident radiation for a given detection period;
d) lower the temperature of the scintillating optical guides to the first or a third temperature level; and
e) repeat a) to d).

In general the various aspects of the invention may be combined and coupled in any way possible within the scope of the invention. These and other aspects, features and/or advantages of the invention will be apparent from and elucidated with reference to the embodiments described hereinafter.

### BRIEF DESCRIPTION OF THE DRAWINGS

Embodiments of the invention will be described, by way of example only, with reference to the drawings, in which

FIG. 1 schematically illustrates an overview of a particle therapy facility;

FIG. 2 schematically illustrates a detector;

FIG. 3 schematically illustrates a cross-section of an optical fibre; and

FIG. 4 schematically illustrates the effect of heating the fibres during detection.

### DESCRIPTION OF EMBODIMENTS

The following description focuses on embodiments of the present invention applicable to the field of particle therapy. While embodiments of the present invention advantageously may be used in this field, the invention is however not limited to this type of application. In general the embodiments of the present invention may be used for monitoring the transversal profile of any radiation beam, which is capable of generating scintillation light in optical guides in accordance with embodiments of the present invention. Moreover, the following description focuses on embodiments of the optical guides in the form of optical fibres. While this may be an advantageous embodiment, the invention is however not limited to this type of application.

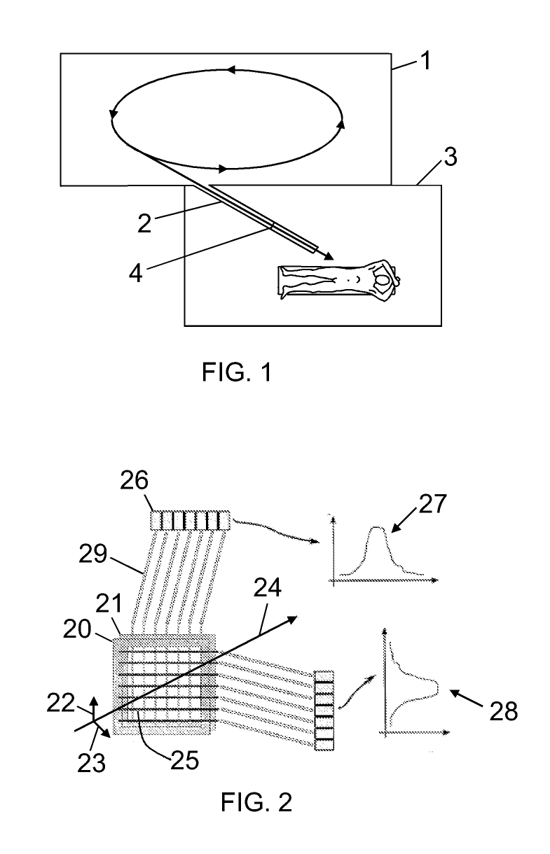

FIG. 1 schematically illustrates an overview of a particle therapy facility. In particle therapy localized cancer tumours are treated by irradiation the cancerous tissue with ion beams, e.g. protons or Carbon ions. In a particle therapy facility energetic ion beams are generated in an accelerator complex 1, such as a synchrotron or cyclotron facility. A synchrotron or cyclotron facility typically comprises a number of extraction lines. Here a single extraction line 2 is illustrated, which extracts the ion beam into a treatment room 3 for treating the patient. Prior to and during radiation of the patient, the beam properties are monitored. An important aspect of this monitoring is a monitoring of the transversal beam profile. Embodiments of the present invention provide a detector 4 for detecting the transversal profile of the particle beam.

FIG. 2 schematically illustrates a detector in accordance with embodiments of the present invention.

Two detector elements 20, 21 are provided for detecting the transversal radiation beam profile 27, 28 in two orthogonal directions 22, 23 which again are orthogonal to the beam 24. The two detector elements are similar, except for a 90 degree rotation.

Each detector-element comprises a set of scintillating optical fibres 25 arranged in an array. The fibres are arranged in a common plane in a linear array. The fibres are supported by a frame. By arranging the fibres in a linear array a simple Cartesian mapping is provided. This arrangement of fibres may be referred to as a harp configuration.

When an ion penetrates the scintillating optical fibre, scintillating light is created within the optical fibre. Due to internal total reflection, the light is transported out of the fibre. The light from each fibre may be detected by appropriate photodetectors 26. The photodetector may be a signal amplified semiconductor (e.g. Si, Ge, InGaAs) photodetector. Alternatively, the light may for example be detected by a segmented photomultiplier, an avalanche photodiode, a CCD camera. The photodetector should be capable of detecting electromagnetic radiation in the relevant wavelength range, i.e. in the range of the scintillating light. For rare earth doped optical fibres this range comprises the near-infrared range.

The coupling 29 between the scintillating optical fibres and the photodetector may be provided by optical fibres, such as standard silica fibres. These fibres may be referred to as transport fibres 29. Short transport fibres may be used if a compact integrated detector is desired, whereas long transport fibres may be used if it is desired to separate in space the detector elements and the photodetectors. To increase the amount of detected light, the fibre ends opposite the transport fibres may be provided with a reflective end, such as a deposited metal film or dielectric coating.

Successful measurements using a detector generally described in connection with FIG. 2 have been performed at the accelerator facility HIT in Heidelberg. The detector had an active area of 6×6 cm and mounted with 8 fibres in each direction. The detector was irradiated with proton beams with energy in the range of E=51-221 MeV/u and intensity in the range of I=8×10⁷-3×10⁹ particles/sec, and carbon beams with energy in the range of E=108-430 MeV/u and intensity in the range of I=2×10⁶-8×10⁷ particles/sec.

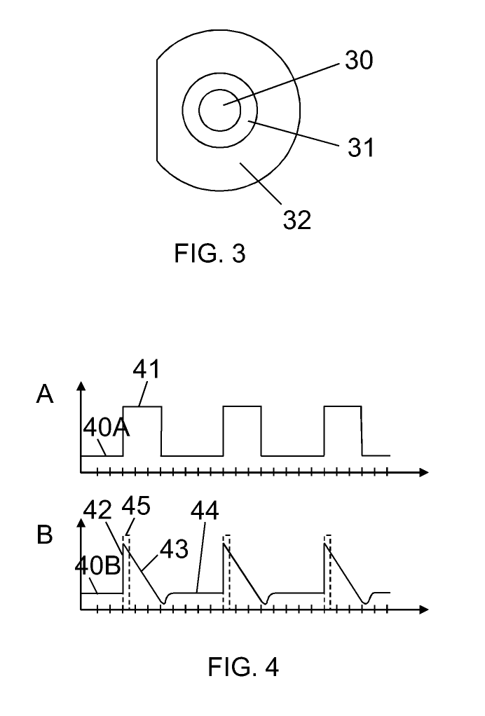

FIG. 3 schematically illustrates a cross-section of a commercially available optical fibre e.g. available from the company CorActive (http://www.coractive.com) and nLIGHT (http://www.nlight.net). A number of geometric configurations of the optical fibre may be used. In the Figure an example is provided where the optical fibre comprises a double core: a central core 30, and an outer core 31, as well as a cladding 32. The central core 30 is the optical fibre part where the scintillating light is generated, i.e. the rare earth doped optical fibre part. In an embodiment, the central core is an Yb doped silica-fibre. The cladding 32 is to ensure total internal reflection within the core region (central and outer core). Thus the cladding is present in order to provide an envelope of the core region with a lower refractive index. In addition, the cladding 32 also renders the fibre robust so that the fibre will not easily deteriorate upon handling. In an embodiment, the cladding is a silica-cladding with a truncated spherical cross-section. In an embodiment, the doped central core is 85 micrometers in diameter, whereas the entire fibre is 250 micrometers across. In an alternative embodiment there is no cladding and/or outer core and the total internal reflection is due to scattering at the core-air (or core-vacuum) interface. Commercial optical fibres are typically provided with a polymer coating. Such coatings may be removed prior to mounting the optical fibre.

FIG. 4 schematically illustrates the effect of heating the fibres during detection. FIG. 4A illustrates the imposed temperature as a function of time. Successive heating cycles are provided, for example by raising the temperature from 25° C. to 125° C. for 3 seconds every 8th second. Other temperature cycles can be used.

The effect of increasing the temperature is a short increase in detected scintillating light. The increase is schematically illustrated in FIG. 4B schematically showing the corresponding detected scintillation light. Prior to the temperature increase 40A, 40B the scintillating fibres are at room temperature (or possibly actively maintained at a constant temperature), at this temperature the detected light is at a first level. Upon the temperature increase 41, an increase in the detected light 42 is also detected. The increase is observed to be as much as a ten times increase. The increase in detected light, however, only lasts for a short period of a few seconds, after which the detected light decreases 43, even down to a level slightly below the initial level. However, when the heating is switched off, the light yield recovers to the same level 44 as prior to the temperature increase. In an embodiment, the detector may be gated by gate signal so that the detector is only detecting the light in a short period 45 around the maximum sensitivity and thereby providing an extremely sensitive detector. Measurements performed at the accelerator facility at Rigshospitalet in Copenhagen have shown this behaviour.

Although the present invention has been described in connection with the specified embodiments, it is not intended to be limited to the specific form set forth herein. Rather, the scope of the present invention is limited only by the accompanying claims. In the claims, the term “comprising” does not exclude the presence of other elements or steps. Additionally, although individual features may be included in different claims, these may possibly be advantageously combined, and the inclusion in different claims does not imply that a combination of features is not feasible and/or advantageous. In addition, singular references do not exclude a plurality. Thus, references to “a”, “an”, “first”, “second” etc. do not preclude a plurality. Furthermore, reference signs in the claims shall not be construed as limiting the scope.

1. A radiation detector for detecting incident radiation, the detector comprising:
at least a first detector element, wherein the first detector element comprises a set of scintillating optical guides arranged in an array for detecting a transversal radiation beam profile; such that radiation incident on an optical guide generates scintillating light signals within the optical guide; and wherein the set of scintillating optical guides are provided in a glass-based material doped with a rare earth dopant.

2. The radiation detector according to claim 1, wherein the rare earth dopant is selected from the group consisting of Ytterbium, Holmium, Thulium and Erbium.

3. The radiation detector according to claim 1, wherein the glass-based material is silicate-glass based.

4. The radiation detector according to claim 1, wherein the ratio between clustered dopant species and isolated dopant species is below 50%.

5. The radiation detector according to claim 1, wherein the dopant concentration is in the range of 0.1 per mil to 10 percent in weight.

6. The radiation detector according to claim 1, wherein the optical guide is in the form of an optical fibre that does not comprise a polymer coating.

7. The radiation detector according to claim 1, wherein an output of the detector is linear with an intensity of the incident radiation.

8. The radiation detector according to claim 1, wherein the optical guides have been pre-treated by exposure to penetrating ionizing radiation.

9. The radiation detector according to claim 1, wherein the dopant is Ytterbium and wherein the ratio between Ytterbium in the second ionizing state and Ytterbium in the third ionizing state is larger than 1%.

10. The radiation detector according to claim 1, wherein the detector further comprises a heating element for heating the scintillating optical guides.

11. The radiation detector according to claim 1, wherein each scintillating optical guide is coupled to a photodetector for detecting the generated scintillating light signal.

12. The radiation detector according to claim 11, wherein the coupling between the scintillating optical guides and the photodetector are based on optical guides.

13. The radiation detector according to claim 11, wherein the photodetector is capable of detecting electromagnetic radiation in the near-infrared range.

14. (canceled)

15. A method of fabricating a radiation detector for detecting incident radiation, the method comprising:
providing a set of scintillating optical guides, the scintillating optical guides being provided in a glass-based material doped with a rare earth dopant; and
arranging the set of scintillating optical guides in at least a first detector element, by arranging the optical guides in an array for detecting a transversal radiation beam profile.

16. The method according to claim 15, wherein the optical guides are exposed to penetrating ionizing radiation either prior to or after arranging the guides on the detector element.

17. A method of operating the radiation detector set forth in claim 10, wherein said radiation detector further comprises a photodetector comprising:
a) maintaining the scintillating optical guides at a first temperature level;
b) raising the temperature of the scintillating optical guides to a second temperature level;
c) detecting the scintillating light generated by the incident radiation for a given detection period while the temperature of the scintillating optical guides is at the second temperature level;
d) lowering the temperature of the scintillating optical guides to the first or a third temperature level; and
e) repeating steps a) to d).
